(19) United States
(12) Patent Application Publication
(10) Pub. No.: US 2015/0113402 A1
(43) Pub. Date: Apr. 23, 2015

(54) INFORMATION PROCESSING DEVICE, METHOD FOR CONTROLLING INFORMATION PROCESSING DEVICE, OUTPUT DEVICE, ELECTRONIC MACHINE, CONTROL PROGRAM, AND STORAGE MEDIUM

(71) Applicant: SHARP KABUSHIKI KAISHA, Osaka-shi, Osaka (JP)

(72) Inventors: Taisuke Hara, Osaka-shi (JP); Shigehiro Torii, Osaka-shi (JP); Eiji Fumimoto, Osaka-shi (JP); Tomoyuki Katayama, Osaka-shi (JP)

(73) Assignee: SHARP KABUSHIKI KAISHA, Osaka-shi, Osaka (JP)

(21) Appl. No.: 14/391,358

(22) PCT Filed: Jun. 12, 2013
(86) PCT No.: PCT/JP2013/066255

§ 371 Date: Oct. 8, 2014

(30) Foreign Application Priority Data
Jun. 18, 2012 (JP) 2012-137228
Jun. 18, 2012 (JP) 2012-137229

(51) Int. Cl. G06F 3/0484; G06F 3/0485

(52) U.S. Cl. CPC G06F 3/04847; G06F 3/0485
USPC 715/716

(57) ABSTRACT

A control section (11a) disclosed includes a length measuring section (12) for measuring the length (2) of the path (4b) extending from a specified position (5a) to a specified position (5b) both detected by an input surface (41), a rate setting section (14a) for setting the rate (3) of conjunction between a user operation (4a) and movement of a locator (7), and a position information transmitting section (15a) for transmitting, as information on the position of the locator (7) as moved through the user operation (4a), information on a position on a seek bar (6) which position can be calculated from the length (2) and the rate (3).

### TECHNICAL FIELD

The present invention relates to, for example, an information processing device that transmits information on the position of a locator on a seek bar to an output device to allow the output device to specify a time period corresponding to how much of content the output device is supposed to have outputted.

### BACKGROUND ART

In a case where a user operates an electronic device to output a desired portion of content, the user typically specifies a time period corresponding to how much of the content is supposed to have been outputted (that is, a time period that an output device will have spent in outputting the content continuously from the beginning up to the desired portion).

With reference to FIG. 8, the description below deals with an example of how a user specifies the time period on a conventional electronic device. FIG. 8 is a diagram schematically illustrating how a user moves a locator 7 from side to side on a seek bar 6 displayed on a conventional electronic device to specify a time period corresponding to how much of content is supposed to have been outputted.

As illustrated in FIG. 8, information terminals (for example, smartphones), some household game devices, and information processing devices (for example, personal computers) display a seek bar 6 that indicates through movement of a locator 7 how much of content the electronic device has outputted. The user can move the locator 7 on such a seek bar 6 to specify a time period corresponding to how much of content is supposed to have been outputted.

There has been conducted extensive research on interfaces for the above operation. Patent Literature 1 cited below, for example, discloses an information processing device that does not require the user to perform a step-by-step operation and that allows the user to easily select a time width indicated by a proximate time axis. Patent Literature 2 cited below discloses a reproduction control device that displays a user interface for controlling reproduction of time-series data, the user interface allowing the user to experience a consistent operational feeling regardless of the length of time necessary to reproduce all the time-series data.

Patent Literature 3 cited below discloses an information processing device that allows the user to simply perform an easy scroll operation for fine adjustment of display. Patent Literature 4 cited below discloses a content reproducing device that shows an indicator for skipping scenes, the indicator having a value that becomes progressively greater as farther away from the starting point. Patent Literature 5 cited below discloses a reproducing device that accurately specifies a reproduction location for audio/moving image data. Patent Literature 6 cited below discloses an input device that allows the user to operate it intuitively in controlling reproduction of video data.

### CITATION LIST

Patent Literature 1

Japanese Patent Application Publication, Tokukai, No. 2012-44474 A (Publication Date: Mar. 1, 2012)

Patent Literature 2

Japanese Patent Application Publication, Tokukai, No. 2008-33743 A (Publication Date: Feb. 14, 2008)

Patent Literature 3

Japanese Patent Application Publication, Tokukai, No. 2009-295147 A (Publication Date: Dec. 17, 2009)

Patent Literature 4

Japanese Patent Application Publication, Tokukai, No. 2009-17486 A (Publication Date: Jan. 22, 2009)

Patent Literature 5

Japanese Patent Application Publication, Tokukai, No. 2010-211881 A (Publication Date: Sep. 24, 2010)

Patent Literature 6

Japanese Patent Application Publication, Tokukai, No. 2006-302348 A (Publication Date: Nov. 2, 2006)

### SUMMARY OF INVENTION

### Technical Problem

The description below deals in detail with a problem with conventional electronic devices with reference to FIG. 9. FIG. 9 is a diagram schematically illustrating a relationship between variables necessary for a calculation performed in moving a locator 7 on a seek bar 6 displayed on a conventional electronic device.

As illustrated in FIG. 9, in a case where the user has moved the locator 7 by b [m], the electronic device starts outputting content from a location as moved forward by R×b/1 [second], where R [second] represents the remaining time for the content, and 1 [m] represents the length of that portion of the seek bar 6 which corresponds to the remaining time of the content. Conventional electronic devices are problematic in that it is difficult for the user in a case where the remaining time of the content is long to specify a location as moved forward.

In a case where, for instance, R=1800 seconds (30 minutes) and the user wants to move the reproduction location forward by 60 seconds (1 minute), even with 1=0.05 m (50 mm), the user needs to move the locator 7 over an extremely small distance of b=0.0017 m (1.7 mm). It is almost impossible to perform such an operation in view of, for example, (i) the ability of input equipment to detect operations and (ii) the accuracy of human operations.

The conventional techniques disclosed in Patent Literatures 1 to 6 cited above are either unable to reliably solve the problem with conventional electronic devices or able to solve that problem but, as a result of solving it, give rise to another problem.

For example, while the devices disclosed in Patent Literatures 2 and 3 cited above each display a separate interface to show an image of the position of a locator and its vicinity, such a plurality of interfaces are shown at the same time, making complicated an operation of finely adjusting the position of the locator. The devices of Patent Literatures 2 and 3 thus cannot be operated intuitively. Further, the device disclosed in Patent Literature 4 cited above shows an indicator having a value that becomes progressively greater as the position specified by the user is farther away from the current position of the locator. This makes it difficult for the user to understand the relationship between the distance over which the user moves a finger and the position of the locator. The other Patent Literatures also fail to reliably solve the above problem as well.

The present invention has been accomplished in view of the above problem. It is an object of the present invention to provide, for example, an information processing device that allows the user to easily specify a time period corresponding to how much of content is supposed to have been outputted and that consequently allows the user to enjoy improved convenience during output of the content.

### Solution to Problem

In order to solve the above problem, the present invention provides, as one mode thereof, an information processing device that allows a seek bar to be displayed which seek bar shows movement of a locator to indicate an amount of content which amount an output device has outputted and that is capable of specifying, by transmitting information on a position of the locator on the seek bar to the output device, a time period corresponding to an amount of the content which amount the output device is supposed to have outputted, the information processing device including: measuring means for measuring, in response to an input surface of an electronic device detecting an operation by a user at a position on the input surface, a length of a path extending from (i) a first specified position for the operation by the user, the first specified position being first detected on the input surface, to (ii) a second specified position for the operation by the user, the second specified position being further detected on the input surface after movement of the operation by the user on the input surface; setting means for setting a rate of conjunction between the operation by the user and the movement of the locator in correspondence with the length of the path, which length has been measured by the measuring means; and transmitting means for transmitting, as the information on the position of the locator as moved through the operation by the user, information on a position on the seek bar which position is capable of being calculated from the length of the path, which length has been measured by the measuring means, and the rate, which has been set by the setting means.

In order to solve the above problem, the present invention provides, as one mode thereof, a method for controlling an information processing device that allows a seek bar to be displayed which seek bar shows movement of a locator to indicate an amount of content which amount an output device has outputted and that is capable of specifying, by transmitting information on a position of the locator on the seek bar to the output device, a time period corresponding to an amount of the content which amount the output device is supposed to have outputted, the method including: a measuring step of measuring, in response to an input surface of an electronic device detecting an operation by a user at a position on the input surface, a length of a path extending from (i) a first specified position for the operation by the user, the first specified position being first detected on the input surface, to (ii) a second specified position for the operation by the user, the second specified position being further detected on the input surface after movement of the operation by the user on the input surface; a setting step of setting a rate of conjunction between the operation by the user and the movement of the locator in correspondence with the length of the path, which length has been measured in the measuring step; and a transmitting step of transmitting, as the information on the position of the locator as moved through the operation by the user, information on a position on the seek bar which position is capable of being calculated from the length of the path, which length has been measured in the measuring step, and the rate, which has been set in the setting step.

### Advantageous Effects of Invention

The present invention provides, as one mode thereof, an information processing device or method for controlling an information processing device that advantageously allows the user to easily specify a time period corresponding to how much of content is supposed to have been outputted and that consequently allows the user to enjoy improved convenience during output of the content.

### BRIEF DESCRIPTION OF DRAWINGS

FIG. 1 is a block diagram illustrating a main configuration of a smartphone of a first embodiment of the present invention.

FIG. 2 is a diagram schematically illustrating how the smartphone illustrated in FIG. 1 operates.

FIG. 3 is a flowchart illustrating an example process performed by the smartphone illustrated in FIG. 1.

FIG. 4 is a block diagram illustrating a main configuration of a smartphone of a second embodiment of the present invention.

FIG. 5 is a diagram schematically illustrating how the smartphone illustrated in FIG. 4 operates.

FIG. 6 shows diagrams schematically illustrating how the smartphone illustrated in FIG. 4 operates differently, where (a) of FIG. 6 illustrates a case where a locator is moved behind a user's finger to follow it along the direction extending from a specified position to another specified position, and (b) of FIG. 6 illustrates a case where a locator is moved ahead of a user's finger to lead it along the direction extending from a specified position to another specified position.

FIG. 7 is a flowchart illustrating an example process performed by the smartphone illustrated in FIG. 4.

FIG. 8 is a diagram schematically illustrating how a user moves a locator from side to side on a seek bar displayed on a conventional electronic device to specify a time period corresponding to how much of content is supposed to have been outputted.

FIG. 9 is a diagram schematically illustrating a relationship between variables diagram schematically illustrating a relationship between variables necessary for a calculation performed in moving a locator on a seek bar displayed on a conventional electronic device.

### DESCRIPTION OF EMBODIMENTS

### Embodiment 1

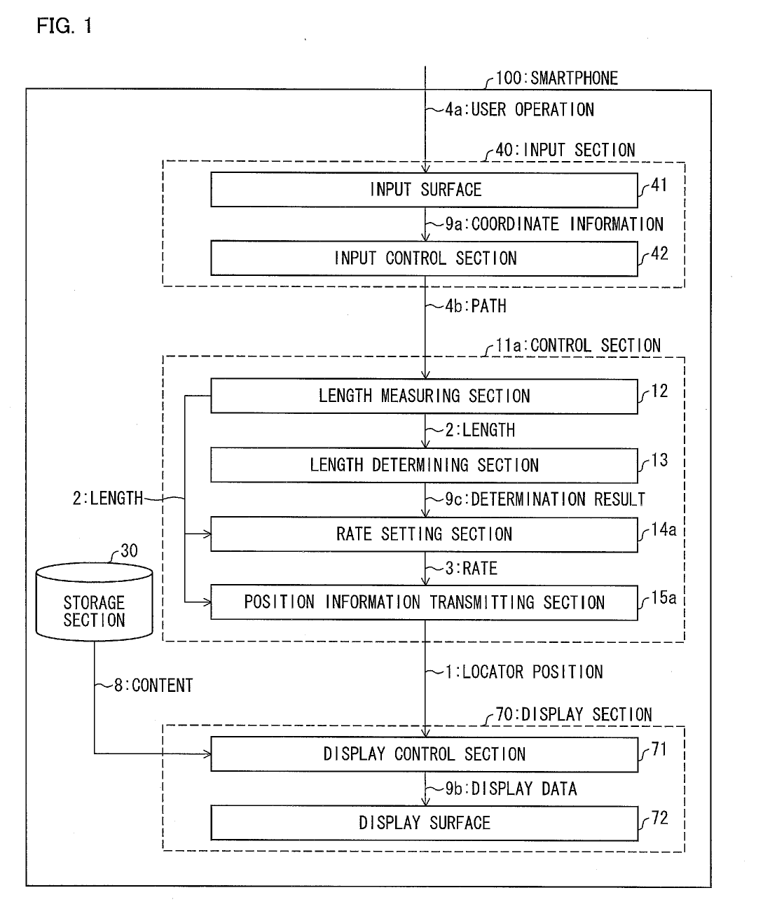

A first embodiment (Embodiment 1) of the present invention is described below in detail with reference to FIGS. 1 through 3.

[Arrangement of Smartphone 100]

The description below deals with an arrangement of a smartphone 100 of the first embodiment of the present invention with reference to FIG. 1. FIG. 1 is a block diagram illustrating a main configuration of the smartphone 100.

The smartphone (electronic device) 100 is an electronic device including an input surface 41 capable of detecting a position specified through a user operation (operation by a user) 4a. The smartphone 100 performs functions, equivalents of which may also be performed by, for example, a mobile telephone, a personal computer, or a tablet terminal. In other words, the electronic device is not necessarily a smartphone as long as it is an electronic device that includes an input surface capable of detecting a position specified through an operation by a user and that is capable of inputting and outputting necessary information.

The smartphone 100 includes an input section 40 (that is, an input surface 41 and an input control section 42), a control section 11a (that is, a length measuring section 12, a length determining section 13, a rate setting section 14a, and a position information transmitting section 15a), a display section 70 (that is, a display control section 71 and a display surface 72), and a storage section 30.

To ensure conciseness, the description below of the arrangement and the block diagram of FIG. 1 omit discussions and illustrations of what is not directly related to the present embodiment. The smartphone 100 may, however, alternatively include such omitted elements in accordance with the actual situation in which the present embodiment is practiced. Further, while in the present embodiment, the control section 11a and the display section 70 are built in the smartphone 100 as illustrated in FIG. 1, the control section 11a and the display section 70 may alternatively be external equipment provided outside the smartphone 100 and communicably connected to the smartphone 100.

(Input Section 40)

The input section 40 accepts a user operation 4a. The input section 40 includes an input surface 41 and an input control section 42.

The input surface 41 outputs to the input control section 42 two-dimensional coordinate information 9a indicative of what position on the input surface 41a finger (or a thumb) of the user's is touching the input surface 41. The input surface 41 is preferably a touch panel in the present embodiment. The input surface 41 is, however, not limited to a touch panel in terms of hardware as long as it is input equipment capable of detecting a touch position of an operation by the user.

The user may use a pointing tool such as a stylus instead of a finger for input to the smartphone 100. Thus, the above term “finger of the user's” covers in its scope a pointing tool such as a stylus. Further, while the previous paragraph describes the user's finger touching the input surface, the smartphone 100 may, in a case where the input surface 41 is, for example, a touch panel capable of detecting proximity of a finger, detect proximity of a finger of the user's to the input surface 41 to operate similarly to the above case of the input surface 41 being a touch panel capable of detecting a touch position.

The input control section 42 detects the path 4b of a user operation 4a on the input surface 41. Specifically, the input control section 42 obtains, from the input surface 41 at predetermined time intervals, coordinate information 9a indicative of a position on the input surface 41 which position has been specified by the user dragging, with use of a finger, a locator 7 displayed on the input surface 41.

The description herein uses the term “drag” as above to refer to an operation of the user's moving a finger on the input surface 41 as if to slide the finger on the input surface. The description herein further uses (i) the term “specified position (first specified position) 5a” to refer to a position whose information is obtained at a timing and (ii) the term “specified position (second specified position) 5b” to refer to a position whose information is obtained at a subsequent timing. The input control section 42 outputs to a length measuring section 12 of the control section 11a information on a path 4b extending from a specified position 5a to a specified position 5b.

(Control Section 11a)

The control section (information processing device) 11a allows a seek bar 6 to be displayed which shows movement of the locator 7 to indicate how much of content 8 the display section 70 has outputted. The control section 11a transmits information on the position of the locator 7 on the seek bar 6 to the display section 70 to allow the display section 70 to specify a time period corresponding to how much of content 8 the display section 70 has outputted.

The content 8 is, for example, a television program broadcast by a broadcasting station, and refers to an individual information item provided by any information source (for example, the Internet, television broadcasting, satellite broadcasting, cable television broadcasting, radio broadcasting, or a digital versatile disk [DVD]). The content 8 may be a video image, a still image, music, voice, writing, a character, a mathematical expression, a numeral, a symbol, or any combination thereof.

The above expression “time period corresponding to how much of . . . outputted” refers to a time period that the display section 70 will have spent (that is, a time period that will have elapsed) in displaying content 8 continuously from the beginning up to a point. Such a “time period corresponding to how much of . . . outputted” is typically indicated as, for example, “reproduction location” in a case where the content 8 is a moving image or the like. To avoid confusion with the “position” of the locator 7 or that “position” on the input surface 41 which is specified through a user operation 4a, the description below uses expressions such as “time period corresponding to how much of . . . outputted (content 8 from the beginning)” and “output time period” (that is, not “position” but “time period”) to indicate a reproduction location.

The control section 11a has various functions that may be performed by, for example, a central processing unit (CPU) executing programs stored on a memory element such as a random access memory (RAM) or flash memory. The control section 11a includes a length measuring section 12, a length determining section 13, a rate setting section 14a, and a position information transmitting section 15a.

The length measuring section (measuring means) 12, in response to the input surface 41 detecting a user operation 4a at a position on the input surface 41, measures the length 2 of a path 4b extending from (i) a specified position 5a at which the input surface 41 has first detected the user operation 4a to (ii) a specified position 5b at which the input surface 41 has further detected the user operation 4a of moving a finger on the input surface 41.

Specifically, the length measuring section 12 measures the length 2 of the path 4b, information on which has been inputted from the input control section 42, and outputs information on the result of measuring the length 2 to the length determining section 13, the rate setting section 14a, and the position information transmitting section 15a. The length 2 is the distance between the points indicated by two different items of coordinate information 9a (namely, the specified position 5a and the specified position 5b) that are inputted at a predetermined time interval from the input control section 42. The length 2 is thus equivalent in meaning to the speed at which the user moves a touch position across the input surface 41.

The length measuring section 12 may measure the length 2 by, for example, calculating the Euclidean distance (that is, the square root of the sum of the square of a horizontal distance between two points and the square of a vertical distance between the two points) between the specified position 5a and the specified position 5b on the input surface 41. In a case where the locator 7 is moved only in the horizontal direction in particular, the length measuring section 12 can measure the length 2 by calculating the difference (B−A) between the horizontal coordinate (A) of the specified position 5a and the horizontal coordinate (B) of the specified position 5b. The length 2 may be expressed in any unit, for example, in dots, pixels, points, or centimeters.

The length determining section (first determining means) 13 determines whether the length 2 of the path 4b, measured by the length measuring section 12, is smaller than a predetermined threshold value. The length determining section 13, in other words, determines whether the user is moving a touch position slowly. The description below uses (i) the term “slow speed” to refer to a moving speed for which the length determining section 13 will determine that the user is moving a touch position slowly and (ii) the term “normal speed” to refer to a moving speed for which the length determining section 13 will determine that the user is not moving a touch position slowly.

Specifically, the length determining section 13, upon input of information on the length 2 from the length measuring section 12, compares the length 2 with a predetermined threshold value and outputs to the rate setting section 14a a determination result 9c indicative of whether the length 2 is smaller than the predetermined threshold value. In other words, the length determining section 13 determines that the user is moving a touch position at a “slow speed” if −nsp<dx<nsp and that the user is moving a touch position at a “normal speed” if dx≦−nsp or nsp≦dx, where dx represents the length 2 and nsp represents the predetermined threshold value. The determination result 9c can, for example, simply be a 1-bit flag.

The rate setting section (setting means) 14a sets a rate 3 of conjunction between the user operation 4a and the movement of the locator 7 in correspondence with the length 2 of the path 4b measured by the length measuring section 12. Specifically, the rate setting section 14a, upon input from the length determining section 13 of a determination result 9c indicating that the length 2 is smaller than the predetermined threshold value, (i) sets the rate 3 in correspondence with the length 2, information on which has been inputted from the length measuring section 12, and (ii) outputs information on the rate 3 to the position information transmitting section 15a.

The rate setting section 14a assigns a predetermined value (described later in detail) to the rate 3 of conjunction between the user operation 4a and the movement of the locator 7 to set a rate for such conjunction. The rate setting section 14a may alternatively set the rate 3 in proportion to the length 2 of the path 4b measured by the length measuring section 12.

The position information transmitting section (transmitting means) 15a transmits, as information on the position of the locator 7 as moved through the user operation 4a, information on a position on the seek bar 6 which position can be calculated from (i) the length 2 of the path 4b measured by the length measuring section 12 and (ii) the rate 3 set by the rate setting section 14a.

Specifically, the position information transmitting section 15a outputs to a display control section 71 of the display section 70 information on a position of the locator 7 as moved from its current position on the seek bar 6 by a movement amount equal to the product of the length 2, information on which has been inputted from the length measuring section 12, and the rate 3, information on which has been inputted from the rate setting section 14a. In a case where the length determining section 13 has determined that the length 2 is larger than the predetermined threshold value, the position information transmitting section 15a may output to the display control section 71 of the display section 70 information on a position of the locator 7 as moved from its current position on the seek bar 6 by a movement amount equal to the length 2. The process performed by the position information transmitting section 15a will be described later in detail.

(Display Section 70)

The display section (output device) 70 outputs the content 8. The display section 70 also has various functions that may be performed by, for example, a CPU executing programs stored on a memory element such as a RAM or flash memory. The display section 70 includes a display control section 71 and a display surface 72.

The display control section (calculating means, outputting means) 71 calculates, from a position of the locator 7 on the seek bar 6 information on which position has been received from the position information transmitting section 15a of the control section 11a, a time period corresponding to how much of the content 8 the display section 70 is supposed to have outputted. The display control section 71 then outputs display data 9b to the display surface 72 in such a manner as to start displaying the content 8 on the display surface 72 from a reproduction location immediately after the time period calculated. The display data 9b is, for example, a bitmapped image, an image in another format, or any other data in a format suitable for display.

The display surface 72 displays the display data 9b inputted from the display control section 71. The present embodiment mainly assumes the display surface 72 to be a liquid crystal display (LCD). The display surface 72 is, however, not limited to an LCD in terms of hardware as long as it is a device having a display function (in particular, a flat-panel display). The display surface 72 may include, for example, (i) a display element such as a plasma display panel (PDP) or an electroluminescent (EL) display and (ii) a driver circuit for driving the display element on the basis of display data 9b inputted from the display control section 71.

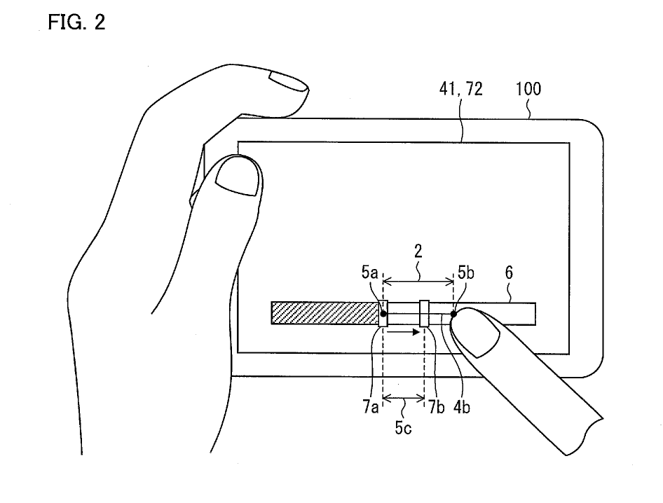

FIG. 1 shows the input surface 41 and the display surface 72 separately to clearly indicate the function of each component. The input surface 41 and the display surface 72 may, however, alternatively be integrated with each other in a case where, for instance, the input surface 41 is a touch panel and the display surface 72 is a liquid crystal display (see FIG. 2). In such a case, the input surface 41 includes a transparent transmissive member (made of glass, for example) in the shape of a rectangular plate, and is formed integrally with the display surface 72 to cover it. This arrangement allows coincidence between (i) a position on the input surface 41 which position is touched by a finger of the user's and (ii) a position on the display surface 72 at which position the display surface 72 displays a figure or the like in response to the touch, thereby allowing the user to feel a natural sense of input.

The storage section 30 is storage equipment capable of storing the content 8. The storage section 30 includes, for example, a hard disk, a silicon state drive (SSD), a semiconductor memory, or a DVD. While in the present embodiment, the storage section 30 is built in the smartphone 100 as illustrated in FIG. 1, the storage section 30 may alternatively be an external memory device provided outside the smartphone 100 and communicably connected to the smartphone 100.

[Method for Calculating Rate 3]

As described above, the rate setting section 14a sets a rate 3 of conjunction between the user operation 4a and the movement of the locator 7 in correspondence with the length 2 of the path 4b measured by the length measuring section 12.

For instance, in a case where the length determining section 13 has determined that the length 2 is smaller than a predetermined threshold value, the rate setting section 14a assigns a predetermined value to the rate 3 of conjunction between the user operation 4a and the movement of the locator 7 to set a rate for such conjunction. Specifically, in an example case where the length 2 is 5 pixels and the predetermined threshold value is 10 pixels, the length 2 is smaller than the predetermined threshold value. The rate setting section 14a thus sets the rate 3 at any real number that is greater than 0 and smaller than 1 (for example, 0.5).

The rate setting section 14a may alternatively, regardless of whether the length 2 is smaller than a predetermined threshold value, set the rate 3 in proportion to the length 2 of the path 4b measured by the length measuring section 12. The rate setting section 14a may, for instance, set the rate 3 at 1 in a case where the length 2 is 10 pixels, at 0.8 in a case where the length 2 is 8 pixels, and at 0.5 in a case where the length 2 is 5 pixels.

The rate setting section 14a may further alternatively set the rate 3 so that the movement amount 5c, that is, the product of the length 2 and the rate 3, has a constant value in any case.

[Method for Determining Locator Position 1]

With reference to FIG. 2, the description below deals with how the position information transmitting section 15a determines a locator position 1. FIG. 2 is a diagram schematically illustrating how the smartphone 100 operates.

As described above, the position information transmitting section 15a determines that a new locator position 1 corresponds to the position (that is, the position of the locator 7b in FIG. 2) of the locator 7 as moved from its current position (that is, the position of the locator 7a in FIG. 2) by the movement amount 5c, that is, the product of the length 2, information on which has been inputted from the length measuring section 12, and the rate 3, information on which has been inputted from the rate setting section 14a.

Specifically, the position information transmitting section 15a calculates a movement amount 5c represented by L by solving L=dx×β, where dx represents the length 2 of the path 4b extending from the specified position 5a to the specified position 5b, and β represents the rate 3 set by the rate setting section 14a. The position information transmitting section 15a then outputs to the display control section 71 of the display section 70 information on the position (locator position 1) of the locator 7b resulting from moving the locator 7a by the above movement amount.

In a case where the rate setting section 14a has set β at any real number that is greater than 0 and smaller than 1, the locator 7 is moved over a distance shorter than the distance (length 2) over which the user has moved a touch position across the input surface 41 (that is, the locator 7 is moved more slowly) as illustrated in FIG. 2. In a case where, for instance, the rate setting section 14a has set the rate 3 at 0.5, the position information transmitting section 15a calculates the movement amount 5c to return a length that is half the length 2, so that the locator 7 is moved over such a half length.

In other words, in a case where the user slowly moves a finger touching the input surface 41, the locator 7 is moved slowly on the seek bar 6 to allow the user to easily specify a time period corresponding to how much of the content 8 the display section 70 is supposed to have outputted.

While the movement amount 5c is proportional to the length 2 (L=dx×β) in the above example, the movement amount 5c may alternatively be proportional to the square of the length 2 (L=dx̂2×β).

[Process Performed by Smartphone 100]

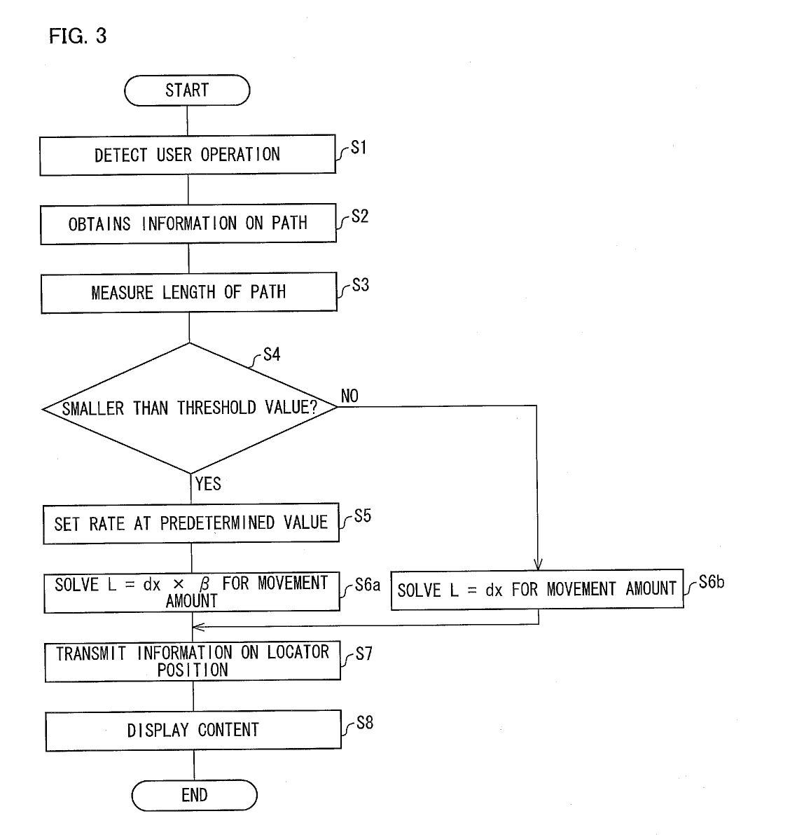

With reference to FIG. 3, the description below deals with the flow of a process performed by the smartphone 100. FIG. 3 is a flowchart illustrating an example process performed by the smartphone 100. In the description below, each “step” shown in parentheses indicates an individual step of a control method.

First, in a case where the input surface 41 has detected a user operation 4a (step 1, or S1 for short), the input control section 42 obtains information on the path 4b of the user operation 4a (S2).

Next, the length measuring section 12 measures the length 2 of the path 4b (S3, measuring step). The length determining section 13 then determines whether the length 2 is smaller than a predetermined threshold value (S4). In a case where the length determining section 13 has determined that the length 2 is smaller than the predetermined threshold value (YES in S4), the rate setting section 14a sets the rate 3 at a predetermined value in correspondence with the length 2 (S5, setting step). The position information transmitting section 15a then calculates a movement amount L that can be calculated from the length 2 and the rate 3 (S6a, transmitting step). In a case where the length determining section 13 has determined that the length 2 is not smaller than the predetermined threshold value (NO in S4), the position information transmitting section 15a calculates a movement amount L that is equal to the length 2 (S6b).

After that, the position information transmitting section 15a transmits, to the display section 70 as information on the position of the locator 7 as moved through the user operation 4a, information on the position of the locator 7b as moved from the current position of the locator 7a by the movement amount L (S7, transmitting step). The display control section 71, in response, starts outputting content 8 from a reproduction location immediately after the time period corresponding to how much of the content the display section 70 is supposed to have outputted, the reproduction location being specified in information on a locator position 1 which information has been transmitted from the position information transmitting section 15a (S8).

[Effects Produced by Smartphone 100]

The smartphone 100 produces the effect of allowing the user to easily specify a time period corresponding to how much of content 8 the display section 70 is supposed to have outputted and thus improving the user's convenience during output of the content 8.

As described above, the conventional techniques discussed above are either unable to reliably solve the problem of difficulty that the user experiences in specifying a time period corresponding to how much of content the display section is supposed to have outputted or able to solve that problem but, as a result of solving it, give rise to another problem: For instance, a plurality of interfaces are shown at the same time, making complicated an operation of finely adjusting the position of the locator, or it is difficult for the user to understand the relationship between the distance over which the user moves a finger and the position of the locator.

The smartphone 100, in contrast, provides the user with only a unified interface for adjusting the position of the locator 7. This advantageously allows the user to avoid the need to perform a complicated operation to finely adjust the position of the locator 7. Further, the seek bar 6 shows graduations separated by widths that are even and do not vary. This advantageously allows the user to easily understand the relationship between the distance over which the user moves a finger and the position of the locator 7.

### Embodiment 2

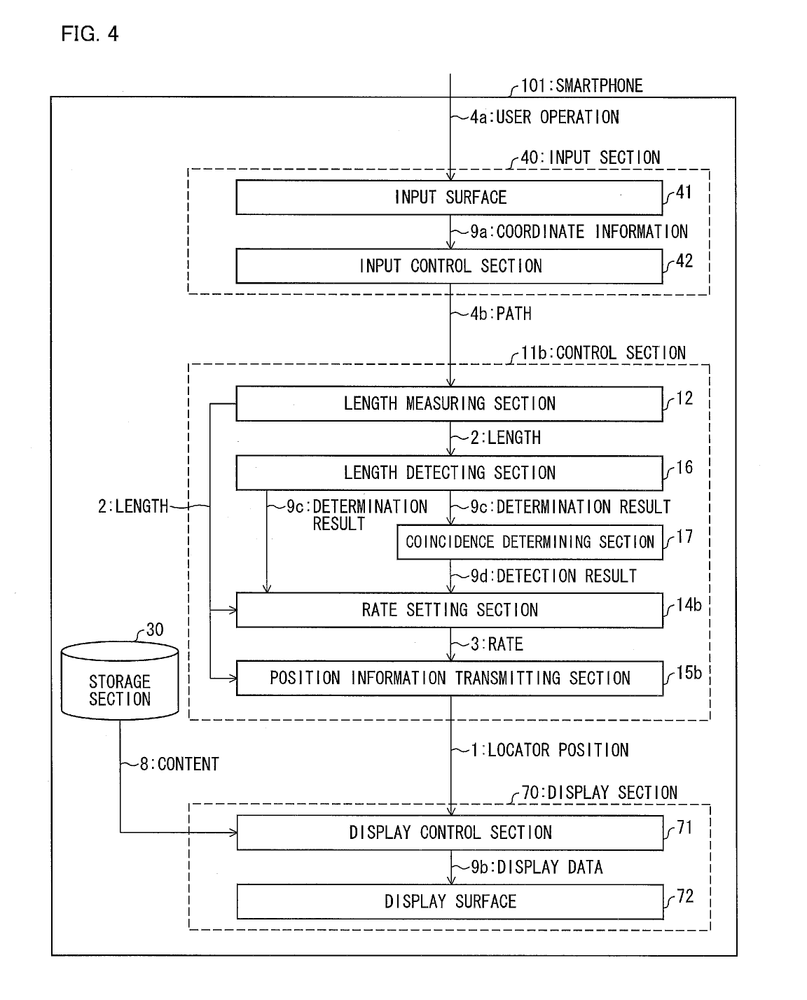

The description below deals in detail with a second embodiment (Embodiment 2) of the present invention with reference to FIGS. 4 through 7. Embodiment 2 may include all the features described for Embodiment 1. Further, the description below uses terms as defined for Embodiment 1.

[Arrangement of Smartphone 101]

The description below deals with an arrangement of a smartphone 101 of the second embodiment of the present invention with reference to FIG. 4. FIG. 4 is a block diagram illustrating a main configuration of the smartphone 101.

The smartphone (electronic device) 101 is an electronic device including an input surface 41 capable of detecting a position specified through a user operation (operation by a user) 4a. The smartphone 101 performs functions, equivalents of which may also be performed by, for example, a mobile telephone, a personal computer, or a tablet terminal. In other words, the electronic device is not necessarily a smartphone as long as it is an electronic device that includes an input surface capable of detecting a position specified through an operation by a user and that is capable of inputting and outputting necessary information.

The smartphone 101 includes an input section 40 (that is, an input surface 41 and an input control section 42), a control section 11b (that is, a length measuring section 12, a length detecting section 16, a coincidence determining section 17, a rate setting section 14b, and a position information transmitting section 15b), a display section 70 (that is, a display control section 71 and a display surface 72), and a storage section 30. In other words, the smartphone 101, as illustrated in FIG. 4, includes a length detecting section 16 and a coincidence determining section 17 in place of the length determining section 13 included in the smartphone 100.

To ensure conciseness, the description below of the arrangement and the block diagram of FIG. 4, as well as FIG. 1, omit discussions and illustrations of what is not directly related to the present embodiment. The smartphone 101 may, however, alternatively include such omitted elements in accordance with the actual situation in which the present embodiment is practiced. Further, while in the present embodiment, the control section 11b and the display section 70 are built in the smartphone 101 as illustrated in FIG. 1, the control section 11b and the display section 70 may alternatively be external equipment provided outside the smartphone 101 and communicably connected to the smartphone 101.

(Input Section 40)

The input section 40 accepts a user operation 4a. The input section 40 includes an input surface 41 and an input control section 42.

The input surface 41 outputs to the input control section 42 two-dimensional coordinate information 9a indicative of what position on the input surface 41a finger (or a thumb) of the user's is touching the input surface 41. The input surface 41 is preferably a touch panel in the present embodiment as well as Embodiment 1. The input surface 41 is, however, not limited to a touch panel in terms of hardware as long as it is input equipment capable of detecting a touch position of an operation by the user.

The user may use a pointing tool such as a stylus instead of a finger for input to the smartphone 101. Thus, the above term “finger of the user's” covers in its scope a pointing tool such as a stylus. Further, while the previous paragraph describes the user's finger touching the input surface, the smartphone 101 may, in a case where the input surface 41 is, for example, a touch panel capable of detecting proximity of a finger, detect proximity of a finger of the user's to the input surface 41 to operate similarly to the above case of the input surface 41 being a touch panel capable of detecting a touch position.

The input control section 42 detects the path 4b of a user operation 4a on the input surface 41. Specifically, the input control section 42 obtains, from the input surface 41 at predetermined time intervals, coordinate information 9a indicative of a position on the input surface 41 which position has been specified by the user dragging, with use of a finger, a locator 7 displayed on the input surface 41.

The input control section 42 outputs to a length measuring section 12 of the control section 11b information on a path 4b extending from a specified position 5a to a specified position 5b.

(Control Section 11b)

The control section (information processing device) 11b allows a seek bar 6 to be displayed which shows movement of the locator 7 to indicate how much of content 8 the display section 70 has outputted. The control section 11b transmits information on the position of the locator 7 on the seek bar 6 to the display section 70 to allow the display section 70 to specify a time period corresponding to how much of content 8 the display section 70 has outputted.

The control section 11b has various functions that may be performed by, for example, a CPU executing programs stored on a memory element such as a RAM or flash memory. The control section 11b includes a length measuring section 12, a length detecting section 16, a coincidence determining section 17, a rate setting section 14b, and a position information transmitting section 15b.

The length measuring section (measuring means) 12, in response to the input surface 41 detecting a user operation 4a at a position on the input surface 41, measures the length 2 of a path 4b extending from (i) a specified position 5a at which the input surface 41 has first detected the user operation 4a to (ii) a specified position 5b at which the input surface 41 has further detected the user operation 4a of moving a finger on the input surface 41.

Specifically, the length measuring section 12 measures the length 2 of the path 4b, information on which has been inputted from the input control section 42, and outputs information on the result of measuring the length 2 to the rate setting section 14b, the position information transmitting section 15b, and the length detecting section 16. The length 2 is the distance between the points indicated by two different items of coordinate information 9a (namely, the specified position 5a and the specified position 5b) that are inputted at a predetermined time interval from the input control section 42. The length 2 is thus equivalent in meaning to the speed at which the user moves a touch position across the input surface 41.

The length measuring section 12 may measure the length 2 by, for example, calculating the Euclidean distance (that is, the square root of the sum of the square of a horizontal distance between two points and the square of a vertical distance between the two points) between the specified position 5a and the specified position 5b on the input surface 41. In a case where the locator 7 is moved only in the horizontal direction in particular, the length measuring section 12 can measure the length 2 by calculating the difference (B−A) between the horizontal coordinate (A) of the specified position 5a and the horizontal coordinate (B) of the specified position 5b. The length 2 may be expressed in any unit, for example, in dots, pixels, points, or centimeters.

The length detecting section (detecting means) 16 determines whether the length 2 of the path 4b, measured by the length measuring section 12, is smaller than a predetermined threshold value. The length detecting section 16, in other words, determines whether the user is moving a touch position slowly. The description below uses (i) the term “slow speed” to refer to a moving speed for which the length determining section 13 will determine that the user is moving a touch position slowly and (ii) the term “normal speed” to refer to a moving speed for which the length determining section 13 will determine that the user is not moving a touch position slowly.

Specifically, the length detecting section 16, upon input of information on the length 2 from the length measuring section 12, compares the length 2 with a predetermined threshold value. If the length detecting section 16 has determined that the length 2 is smaller than the predetermined threshold value, the length detecting section 16 outputs to the rate setting section 14b a determination result 9c indicating that the length 2 is smaller than the predetermined threshold value.

In other words, the length detecting section 16 determines that the user is moving a touch position at a “slow speed” if −nsp<dx<nsp and that the user is moving a touch position at a “normal speed” if dx≦−nsp or nsp≦dx, where dx represents the length 2 and nsp represents the predetermined threshold value. The determination result 9c can, for example, simply be a 1-bit flag.

The length detecting section 16 further detects whether the length 2 of the path 4b, measured by the length measuring section 12, is larger than the predetermined threshold value. The length detecting section 16, in other words, detects whether the user has switched from (i) a state of moving the locator 7 at a “slow speed” to (ii) a state of moving the locator 7 at a “normal speed”.

Specifically, the length detecting section 16 determines through a process similar to above that the length 2 is not smaller than the predetermined threshold value and consequently detects that the length 2 is larger than the predetermined threshold value. The length detecting section 16 then outputs to the coincidence determining section 17 a determination result 9c indicating that the length 2 is larger than the predetermined threshold value.

The coincidence determining section (second determining means) 17, in a case where the length detecting section 16 has detected that the length 2 is larger than the predetermined threshold value, determines whether the specified position 5b coincides with the locator 7.

Specifically, the coincidence determining section 17, upon input from the length detecting section 16 of a determination result 9c indicating that the length 2 is larger than the predetermined threshold value, determines whether the specified position 5b on the input surface 41 coincides with the locator 7 displayed on the display surface 72. The coincidence determining section 17, in a case where it has determined that the specified position 5b coincides with the locator 7, outputs to the rate setting section 14b a determination result 9d indicating that the specified position 5b coincides with the locator 7.

The rate setting section (setting means) 14b sets a rate 3 of conjunction between the user operation 4a and the movement of the locator 7 in correspondence with the length 2 of the path 4b measured by the length measuring section 12.

Specifically, either upon input from the length detecting section 16 of a determination result 9c indicating that the length 2 is smaller than the predetermined threshold value or upon input from the coincidence determining section 17 a determination result 9d indicating that the specified position 5b coincides with the locator 7 displayed, the rate setting section 14b (i) sets the rate 3 in correspondence with the length 2, information on which has been inputted from the length measuring section 12, and (ii) outputs information on the rate 3 to the position information transmitting section 15b.

The rate setting section 14b assigns a predetermined value (described later in detail) to the rate 3 of conjunction between the user operation 4a and the movement of the locator 7 to set a rate for such conjunction.

The rate setting section 14b may alternatively set the rate 3 in proportion to the length 2 of the path 4b measured by the length measuring section 12. The rate setting section 14b may further alternatively set the rate 3 so that the specified position 5b coincides with a locator position 1 calculated from the length 2 of the path 4b and the rate 3.

The position information transmitting section (transmitting means) 15b transmits, as information on the position of the locator 7 as moved through the user operation 4a, information on a position on the seek bar 6 which position can be calculated from (i) the length 2 of the path 4b measured by the length measuring section 12 and (ii) the rate 3 set by the rate setting section 14b and which position is located in a direction toward the specified position 5b.

Specifically, the position information transmitting section 15b outputs to a display control section 71 of the display section 70 information on a position of the locator 7 as moved from its current position toward the specified position 5b on the seek bar 6 by a movement amount equal to the product of (i) the length 2, information on which has been inputted from the length measuring section 12, and (ii) the rate 3, information on which has been inputted from the rate setting section 14b.

In a case where (i) the length detecting section 16 has determined that the length 2 is larger than the predetermined threshold value and (ii) the coincidence determining section 17 has determined that the specified position 5b coincides with the locator 7, the position information transmitting section 15b may output to the display control section 71 of the display section 70 information on a position of the locator 7 as moved from its current position on the seek bar 6 by a movement amount equal to the length 2. The process performed by the position information transmitting section 15b will be described later in detail.

(Display Section 70)

The display section (output device) 70 outputs the content 8. The display section 70 also has various functions that may be performed by, for example, a CPU executing programs stored on a memory element such as a RAM or flash memory. The display section 70 includes a display control section 71 and a display surface 72.

The display control section (calculating means, outputting means) 71 calculates, from a position of the locator 7 on the seek bar 6 information on which position has been received from the position information transmitting section 15b of the control section 11b, a time period corresponding to how much of the content 8 the display section 70 is supposed to have outputted. The display control section 71 then outputs display data 9b to the display surface 72 in such a manner as to start displaying the content 8 on the display surface 72 from a reproduction location immediately after the time period calculated.

The display surface 72 displays the display data 9b inputted from the display control section 71. The present embodiment, as well as Embodiment 1, mainly assumes the display surface 72 to be a liquid crystal display (LCD).

The storage section 30 is storage equipment capable of storing the content 8. The storage section 30 includes, for example, a hard disk, a semiconductor memory, or a DVD. While in the present embodiment, as well as Embodiment 1, the storage section 30 is built in the smartphone 101 as illustrated in FIG. 4, the storage section 30 may alternatively be an external memory device provided outside the smartphone 101 and communicably connected to the smartphone 101.

[Method for Calculating Rate 3]

As described above, the rate setting section 14b sets a rate 3 of conjunction between the user operation 4a and the movement of the locator 7 in correspondence with the length 2 of the path 4b measured by the length measuring section 12.

For instance, in a case where the length detecting section has determined that the length 2 is smaller than a predetermined threshold value, the rate setting section 14b assigns a predetermined value to the rate 3 of conjunction between the user operation 4a and the movement of the locator 7 to set a rate for such conjunction. Specifically, in an example case where the length 2 is 5 pixels and the predetermined threshold value is 10 pixels, the length 2 is smaller than the predetermined threshold value. The rate setting section 14b thus sets the rate 3 at any real number that is greater than 0 and smaller than 1 (for example, 0.5).

The rate setting section 14b may alternatively, regardless of whether the length 2 is smaller than a predetermined threshold value, set the rate 3 in proportion to the length 2 of the path 4b measured by the length measuring section 12. The rate setting section 14b may, for instance, set the rate 3 at 1 in a case where the length 2 is 10 pixels, at 0.8 in a case where the length 2 is 8 pixels, and at 0.5 in a case where the length 2 is 5 pixels.

The rate setting section 14b may further alternatively set the rate 3 so that the movement amount 5c, that is, the product of the length 2 and the rate 3, has a constant value in any case.

[Method for Determining Locator Position 1]

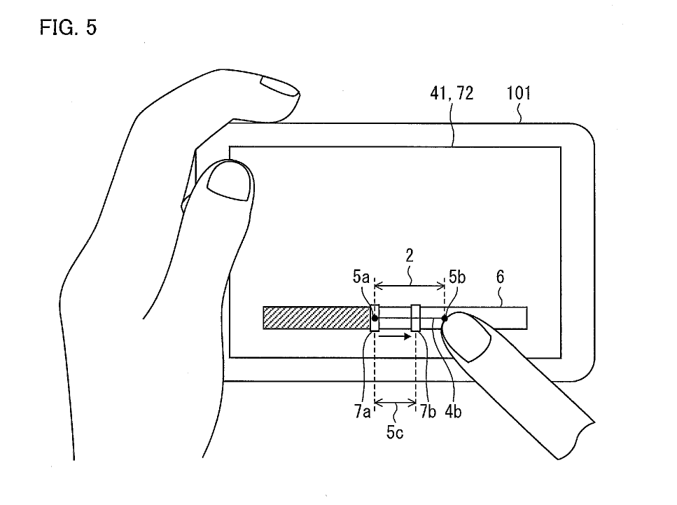

With reference to FIG. 5, the description below deals with how the position information transmitting section 15b determines a locator position 1. FIG. 5 is a diagram schematically illustrating how the smartphone 101 operates.

As described above, the position information transmitting section 15b determines that a new locator position 1 corresponds to the position (that is, the position of the locator 7b in FIG. 5) of the locator 7 as moved from its current position (that is, the position of the locator 7a in FIG. 5) by the movement amount 5c, that is, the product of the length 2, information on which has been inputted from the length measuring section 12, and the rate 3, information on which has been inputted from the rate setting section 14b.

Specifically, the position information transmitting section 15b calculates a movement amount 5c represented by L by solving L=dx×β, where dx represents the length 2 of the path 4b extending from the specified position 5a to the specified position 5b, and β represents the rate 3 set by the rate setting section 14b. The position information transmitting section 15b then outputs to the display control section 71 of the display section 70 information on the position (locator position 1) of the locator 7b resulting from moving the locator 7a by the above movement amount.

In a case where the rate setting section 14b has set β at any real number that is greater than 0 and smaller than 1, the locator 7 is moved over a distance shorter than the distance (length 2) over which the user has moved a touch position across the input surface 41 (that is, the locator 7 is moved more slowly) as illustrated in FIG. 5. In a case where, for instance, the rate setting section 14b has set the rate 3 at 0.5, the position information transmitting section 15b calculates the movement amount 5c to return a length half the length 2, so that the locator 7 is moved over such a half length.

In other words, in a case where the user slowly moves a finger touching the input surface 41, the locator 7 is moved slowly on the seek bar 6 to allow the user to easily specify a time period corresponding to how much of the content 8 the display section 70 is supposed to have outputted.

While the movement amount 5c is proportional to the length 2 (L=dx×β) in the above example, the movement amount 5c may alternatively be proportional to the square of the length 2 (L=dx̂2×β).

[Method for Determining Locator Position 1 after End of Slow Speed]

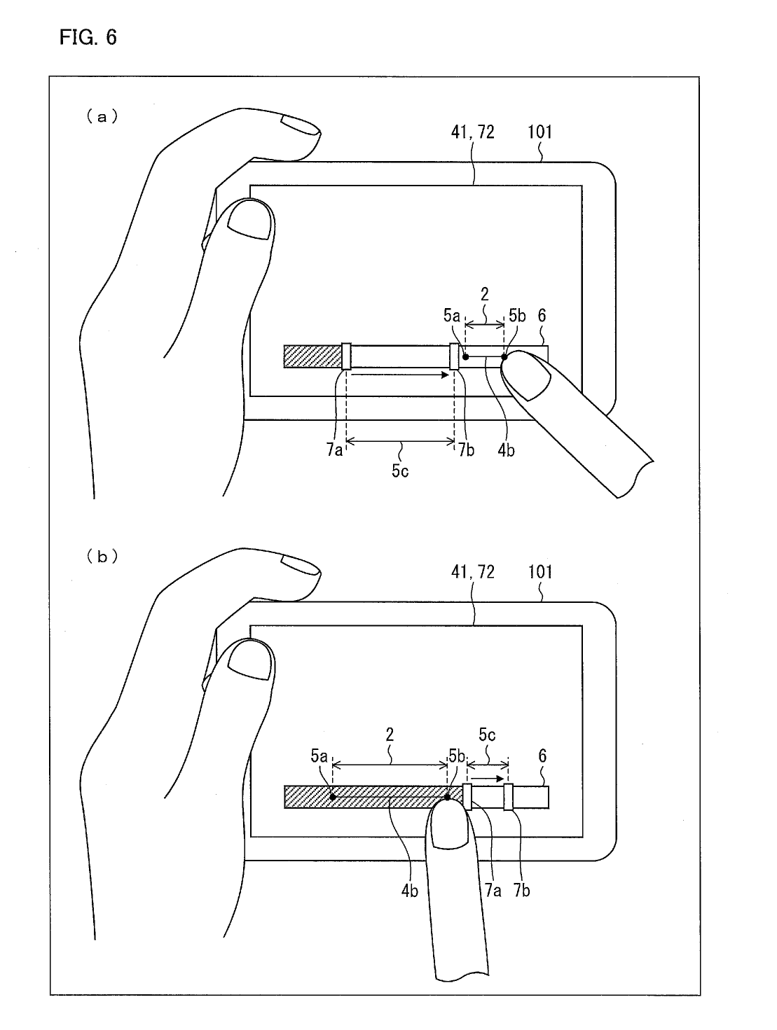

With reference to FIG. 6, the description below deals with how the smartphone 101 operates in a case where the user switches from (i) a state of moving the locator 7 at a “slow speed” to (ii) a state of moving the locator 7 at a “normal speed”. FIG. 6 shows diagrams schematically illustrating how the smartphone 101 operates differently, where (a) of FIG. 6 illustrates a case where the locator 7 is moved behind the user's finger to follow it along the direction extending from a specified position 5a to a specified position 5b (that is, the direction in which the user moves a finger touching the input surface 41), and (b) of FIG. 6 illustrates a case where the locator 7 is moved ahead of the user's finger to lead it along the direction extending from a specified position 5a to a specified position 5b.

In the state where the user is slowly moving a finger on the input surface 41 to move the locator 7 at a “slow speed”, the specified position 5b is separated from the locator 7b as illustrated in FIG. 6. The user will feel awkward about the operation if the separation remains even in a case where the user has started to move the finger on the input surface 41 at an ordinary speed to switch from the above state to a state of moving the locator 7 at a “normal speed”.

To solve the above problem, in a case where the length detecting section 16 has detected that the user has switched the states as above, the smartphone 101, if the specified position 5b is separated from the locator 7b, sets the locator position 1 in such a manner that the locator 7b follows the specified position 5b to become closer thereto (see (a) of FIG. 6) or that the specified position 5b follows the locator 7b to become closer thereto (see (b) of FIG. 6).

In the case where the locator 7 is moved behind the user's finger to follow it in the direction extending from the specified position 5a to the specified position 5b, the smartphone 101 (specifically, the rate setting section 14b) sets the rate 3 (β) at a value greater than 1.0 to increase the movement amount 5c of the locator 7 so that the locator 7b follows the specified position 5b to become closer thereto as illustrated in (a) of FIG. 6.

In the case where the locator 7 is moved ahead of the user's finger to lead it in the direction extending from the specified position 5a to the specified position 5b, the smartphone 101 (specifically, the rate setting section 14b) sets the rate 3 (β) at a value smaller than 1.0 to decrease the movement amount 5c of the locator 7 so that the specified position 5b follows the locator 7 to become closer thereto as illustrated in (b) of FIG. 6.

[Process Performed by Smartphone 101]

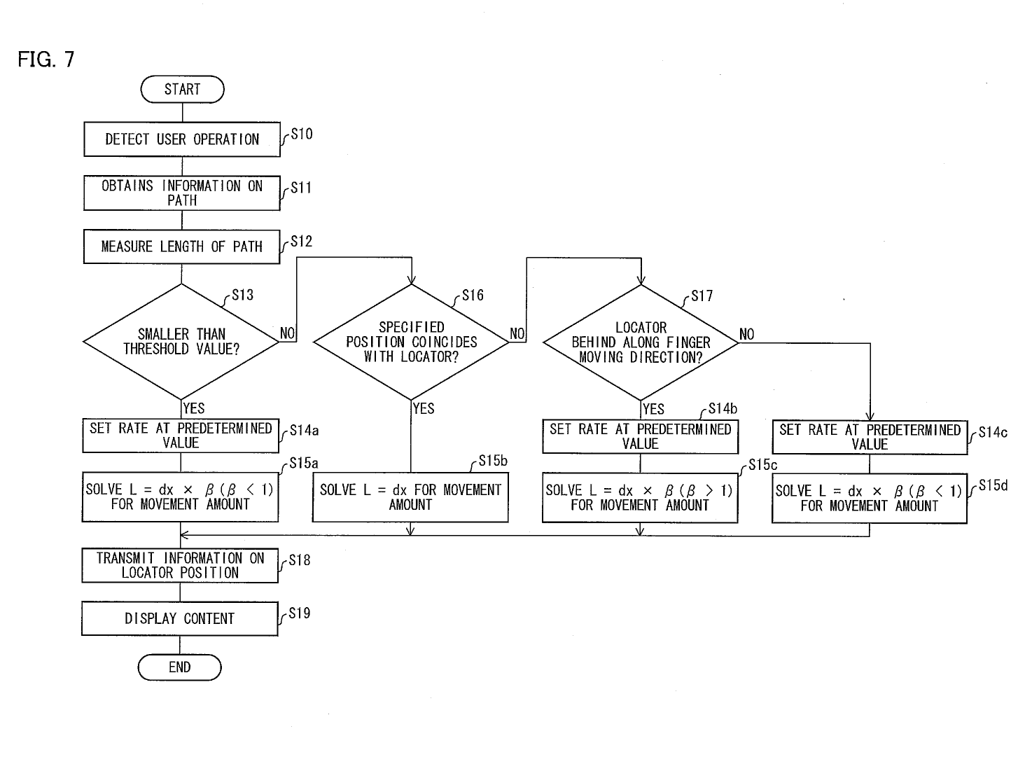

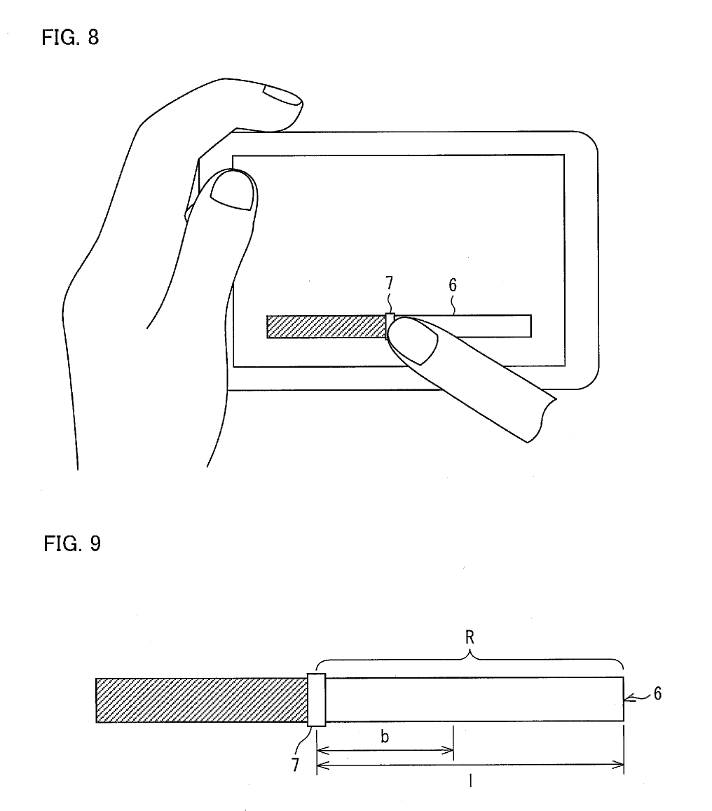

With reference to FIG. 7, the description below deals with the flow of a process performed by the smartphone 101. FIG. 7 is a flowchart illustrating an example process performed by the smartphone 101. In the description below, each “step” shown in parentheses indicates an individual step of a control method.

First, in a case where the input surface 41 has detected a user operation 4a (S10), the input control section 42 obtains information on the path 4b of the user operation 4a (S11).

Next, the length measuring section 12 measures the length 2 of the path 4b (S12, measuring step). The length detecting section 16 then determines whether the length 2 is smaller than a predetermined threshold value (S13). In a case where the length determining section 13 has determined that the length 2 is smaller than the predetermined threshold value (YES in S13), the rate setting section 14b sets the rate 3 at a predetermined value in correspondence with the length 2 (S14a, setting step). The position information transmitting section 15b then calculates a movement amount L that can be calculated from the length 2 and the rate 3 (S15a).

In a case where the length determining section 13 has determined that the length 2 is not smaller than the predetermined threshold value and has consequently detected that the length 2 is larger than the predetermined threshold value (NO in S13, detecting step), the coincidence determining section 17 determines whether the specified position 5b coincides with the locator 7 (S16, determining step). In a case where the coincidence determining section 17 has determined that the specified position 5b coincides with the locator 7 (YES in S16), the position information transmitting section 15b calculates a movement amount L that is equal to the length 2 (S15b).

In a case where the coincidence determining section 17 has determined that the specified position 5b does not coincide with the locator 7 (NO in S16), the coincidence determining section 17 further determines whether the locator 7 is behind the user's finger along the direction in which the user is moving the finger (S17). In a case where the coincidence determining section 17 has determined that the locator 7 is behind the user's finger (YES in S17), the rate setting section 14b sets the rate 3 at a value that corresponds to the length 2 and that is greater than 1 (S14b, setting step), and the position information transmitting section 15b calculates a movement amount L that can be calculated from the length 2 and the rate 3 (S15c).

In a case where the coincidence determining section 17 has determined that the locator 7 is not behind the user's finger (NO in S17), the rate setting section 14b sets the rate 3 at a value that corresponds to the length 2 and that is smaller than (S14c, setting step), and the position information transmitting section 15b calculates a movement amount L that can be calculated from the length 2 and the rate 3 (S15d).

After that, the position information transmitting section 15b transmits, as information on the position of the locator 7 as moved through the user operation 4a, information on a position of the locator 7b as moved from the current position of the locator 7a toward the specified position 5b by the movement amount L, which position is located (S18, transmitting step). The display control section 71, in response, starts outputting content 8 from a reproduction location immediately after the time period corresponding to how much of the content the display section 70 is supposed to have outputted, the reproduction location being specified in information on a locator position 1 which information has been transmitted from the position information transmitting section 15b (S19).

[Effects Produced by Smartphone 101]

The smartphone 101 can reduce separation of the specified position 5b and the locator 7 from each other, and can thus avoid letting the user feel awkward about the operation. With this arrangement, the smartphone 101 produces the effect of allowing the user to easily specify a time period corresponding to how much of content 8 the display section 70 is supposed to have outputted and thus improving the user's convenience during output of the content 8.

As described above, the conventional techniques discussed above are either unable to reliably solve the problem of difficulty that the user experiences in specifying a time period corresponding to how much of content the display section is supposed to have outputted or able to solve that problem but, as a result of solving it, give rise to another problem: For instance, a plurality of interfaces are shown at the same time, making complicated an operation of finely adjusting the position of the locator, or it is difficult for the user to understand the relationship between the distance over which the user moves a finger and the position of the locator.

The smartphone 101, in contrast, provides the user with only a unified interface for adjusting the position of the locator 7. This advantageously allows the user to avoid the need to perform a complicated operation to finely adjust the position of the locator. Further, the seek bar 6 shows graduations separated by widths that are even and do not vary. This advantageously allows the user to easily understand the relationship between the distance over which the user moves a finger and the position of the locator 7.

### Combination of Features (Technical Means) Included in Embodiments

Note that the different features included in the above-described embodiments may be combined as appropriate. In other words, all or part of the features described for the above embodiments may be combined for use in those embodiments, and any embodiment achieved by such combination is also within the technical scope of the present invention.

### Software Implementation Example

Finally, the blocks of the smartphones 100 and 101 (in particular, the blocks included in the control section 11a, the control section 11b, and the display section 70) may be implemented by means of (i) hardware with use of a logic circuit formed on an integrated circuit (IC chip) or (ii) software with use of a CPU.

In the latter case, the smartphones 100 and 101 each include a CPU and memory devices (memory media). The CPU (central processing unit) executes instructions in programs realizing the functions. The memory devices include a ROM (read only memory) which contains programs, a RAM to which the programs are loaded, and a memory containing the programs and various data.

The object of the present invention can also be achieved by mounting, to the smartphone 100 or 101, a computer-readable storage medium containing control program code (executable program, intermediate code program, or source program) for the smartphone 100 or 101, which is software realizing the aforementioned functions, in order for the computer (or CPU, MPU) to retrieve and execute the program code contained in the storage medium.

The storage medium may be, for example, (i) a tape such as a magnetic tape and a cassette tape, (ii) a disk such as a magnetic disk (e.g., a floppy [registered trademark] disk or a hard disk) and an optical disk (e.g., a CD-ROM, an MO, an MD, a DVD, or a CD-R), (iii) a card such as an IC card (memory card) and an optical card, (iv) a semiconductor memory such as a mask ROM, an EPROM, an EEPROM (registered trademark), and a flash ROM, or (v) a logic circuit such as a PLD (programmable logic device) and a FPGA (field programmable gate array).

The smartphone 100 or 101 may be so configured as to be communicable to a communication network so that the above program code can be supplied over that communication network. Such a communication network simply needs to be capable of transmitting a program code, and is not particularly limited. The communication network can be, for example, the Internet, an intranet, an extranet, a LAN, an ISDN, a VAN, a CATV a communications network, a virtual dedicated network (virtual private network), a telephone line network, a mobile communications network, or a satellite communications network.

The transmission medium that forms the above communication network also simply needs to be capable of transmitting a program code, and is not particularly limited in configuration or type. The transmission medium may be, for example, (i) a wired transfer medium such as IEEE 1394, a USB, an electric power line, a cable TV line, a telephone line, and an ADSL (asymmetric digital subscriber line) line, or (ii) a wireless transfer medium such as infrared radiation (IrDA, remote control), Bluetooth (registered trademark), 802.11 wireless, HDR (high data rate), NFC (near field communication), DLNA (digital living network alliance; registered trademark), a mobile telephone network, a satellite line, and a terrestrial digital network. Note that the present invention can also be realized in a form of a computer data signal in which the program codes are embodied by an electronic transmission and which is embedded in carrier waves.

The term “means” as used in the present specification does not necessarily mean physical means. The functions of the means may be realized with use of software as well. Further, the function of single means may be realized with use of two or more physical means, or the functions of two or more means may be realized with use of single physical means.

[Recap]

Mode 1 of the present invention is an information processing device (control section 11a, 11b) that allows a seek bar (6) to be displayed which seek bar shows movement of a locator (7a, 7b) to indicate an amount of content (8) which amount an output device (display section 70) has outputted and that is capable of specifying, by transmitting information on a position of the locator on the seek bar to the output device, a time period corresponding to an amount of the content which amount the output device is supposed to have outputted, the information processing device including: measuring means (length measuring section 12) for measuring, in response to an input surface (41) of an electronic device (smartphone 100, 101) detecting an operation by a user (user operation 4a) at a position on the input surface, a length (2) of a path (4b) extending from (i) a first specified position (specified position 5a) for the operation by the user, the first specified position being first detected on the input surface, to (ii) a second specified position (specified position 5b) for the operation by the user, the second specified position being further detected on the input surface after movement of the operation by the user on the input surface; setting means (rate setting section 14a, 14b) for setting a rate (3) of conjunction between the operation by the user and the movement of the locator in correspondence with the length of the path, which length has been measured by the measuring means; and transmitting means (position information transmitting section 15a, 15b) for transmitting, as the information on the position of the locator as moved through the operation by the user, information on a position on the seek bar which position is capable of being calculated from the length of the path, which length has been measured by the measuring means, and the rate, which has been set by the setting means.

As described above, the conventional techniques discussed above are either unable to reliably solve the problem of difficulty that the user experiences in specifying a time period corresponding to how much of content the display section is supposed to have outputted or able to solve that problem but, as a result of solving it, give rise to another problem: For instance, a plurality of interfaces are shown at the same time, making complicated an operation of finely adjusting the position of the locator, or it is difficult for the user to understand the relationship between the distance over which the user moves a finger and the position of the locator.

With the above arrangement, in contrast, the information processing device measures, in response to the input surface detecting an operation by a user at a position on the input surface, the length of the path extending from (i) a first specified position for the operation by the user, the first specified position being first detected on the input surface, to (ii) a second specified position for the operation by the user, the second specified position being further detected on the input surface after movement of the operation by the user on the input surface.

In other words, the information processing device obtains, from the input surface at predetermined time intervals, information on a position on the input surface which position has been specified by the user, and measures the length (distance) between (i) a first specified position whose information is obtained at a timing and (ii) a second specified position whose information is obtained at a subsequent timing. Note that the above length indicates the distance corresponding to each of the predetermined time intervals, and is thus equivalent in meaning to the speed at which the user moves a touch position across the input surface.

Next, the information processing device sets the rate for conjunction between the operation by the user and the movement of the locator in correspondence with the length. The information processing device then transmits, as the information on the position of the locator as moved through the operation by the user, information on a position on the seek bar which position can be calculated from the length of the path and the rate.

In other words, the information processing device determines, in correspondence with the distance over which the user has moved a touch position across the input surface within a predetermined time interval, the position of the locator as moved, and transmits information on that position determined. The information processing device provides the user with only a unified interface for adjusting the position of the locator. This allows the user to avoid the need to perform a complicated operation to finely adjust the position of the locator. Further, the seek bar shows graduations separated by widths that are even and do not vary. This allows the user to easily understand the relationship between the distance over which the user moves a finger and the position of the locator.

The information processing device, therefore, allows the user to easily specify a time period corresponding to how much of content is supposed to have been outputted and consequently allows the user to enjoy improved convenience during output of the content.

Mode 2 of the present invention is an information processing device which is based on mode 1 and which may be arranged such that the transmitting means transmits, as the information on the position of the locator as moved through the operation by the user, information on a position of the locator as moved from a current position of the locator on the seek bar by a movement amount (5c) equal to a product of the length of the path, which length has been measured by the measuring means, and the rate, which has been set by the setting means.

The information processing device, with the above arrangement, calculates a movement amount for the locator which movement amount is equal to the product of the length of the path and the rate. The information processing device then transmits, as the information on the position of the locator as moved through the operation by the user, information on a position of the locator as moved from the current position of the locator on the seek bar by the above movement amount.

In a case where, for instance, the information processing device has set the rate at 0.5, it calculates the movement amount to return a length half the above length, so that the locator is moved over such a half length. In other words, the locator is moved over a distance shorter than the distance over which the user has moved a touch position across the input surface within a predetermined time interval (that is, the locator is moved slowly).

The information processing device, therefore, allows the user to easily specify a time period corresponding to how much of content is supposed to have been outputted and consequently allows the user to enjoy improved convenience during output of the content.

Mode 3 of the present invention is an information processing device which is based on mode 1 or 2 and which may further include first determining means (length determining section 13) for determining whether the length of the path, which length has been measured by the measuring means, is smaller than a predetermined threshold value, wherein the setting means, in a case where the first determining means has determined that the length of the path is smaller than the predetermined threshold value, sets the rate of the conjunction in correspondence with the length of the path.

The information processing device, with the above arrangement, determines whether the length of the path is smaller than a predetermined threshold value, and only in a case where it has determined that the length of the path is smaller than the predetermined threshold value, sets the rate of the conjunction in correspondence with the length of the path. This allows the information processing device to, in a case where the user is not moving a touch position slowly, cause the locator to move by the same amount as the amount of the movement of the touch position.

The information processing device, therefore, allows the user to easily specify a time period corresponding to how much of content is supposed to have been outputted and that consequently allows the user to enjoy further improved convenience during output of the content.

Mode 4 of the present invention is an information processing device which is based on mode 1 and which may further include: detecting means (length detecting section 16) for detecting whether the length of the path, which length has been measured by the measuring means, is larger than a predetermined threshold value; and second determining means (coincidence determining section 17) for, in a case where the detecting means has detected that the length of the path is larger than the predetermined threshold value, determining whether the second specified position coincides with the position of the locator, wherein: the setting means, in a case where the second determining means has determined that the second specified position does not coincide with the position of the locator, sets the rate of the conjunction between the operation by the user and the movement of the locator; and the transmitting means transmits, as the information on the position of the locator as moved through the operation by the user, information on a position on the seek bar which position is capable of being calculated from the length of the path, which length has been measured by the measuring means, and the rate, which has been set by the setting means, and which position is located in a direction toward the second specified position.

As described above, the conventional techniques discussed above are either unable to reliably solve the problem of difficulty that the user experiences in specifying a time period corresponding to how much of content the display section is supposed to have outputted or able to solve that problem but, as a result of solving it, give rise to another problem: For instance, a plurality of interfaces are shown at the same time, making complicated an operation of finely adjusting the position of the locator, or it is difficult for the user to understand the relationship between the distance over which the user moves a finger and the position of the locator.

With the above arrangement, in contrast, the information processing device measures, in response to the input surface detecting an operation by a user at a position on the input surface, the length of the path extending from (i) a first specified position for the operation by the user, the first specified position being first detected on the input surface, to (ii) a second specified position for the operation by the user, the second specified position being further detected on the input surface after movement of the operation by the user on the input surface.

In other words, the information processing device obtains, from the input surface at predetermined time intervals, information on a position on the input surface which position has been specified by the user, and measures the length (distance) between (i) a first specified position whose information is obtained at a timing and (ii) a second specified position whose information is obtained at a subsequent timing. Note that the above length indicates the distance corresponding to each of the predetermined time intervals, and is thus equivalent in meaning to the speed at which the user moves a touch position across the input surface.

Next, the information processing device, in a case where it has detected that the measured length of the path is larger than a predetermined threshold value, determines whether the second specified position coincides with the position of the locator. The information processing device then, in a case where it has determined that the second specified position does not coincide with the position of the locator, sets the rate of the conjunction between the operation by the user and the movement of the locator, and transmits, as the information on the position of the locator as moved through the operation by the user, information on a position on the seek bar which position can be calculated from the length of the path and the rate and which position is located in a direction toward the second specified position.

In other words, the information processing device, in a case where (i) the user has moved a touch position across the input surface within a predetermined time interval over a long distance, and (ii) the second specified position is consequently separated from the locator, determines that the position of the locator as moved corresponds to a position closer to the second specified position, and transmits information on that position determined.

The information processing device provides the user with only a unified interface for adjusting the position of the locator. This allows the user to avoid the need to perform a complicated operation, as in the conventional techniques discussed above, to finely adjust the position of the locator. Further, the seek bar shows graduations separated by widths that are even and do not vary. This allows the user to easily understand the relationship between the distance over which the user moves a finger and the position of the locator.

The information processing device can, with the above arrangement, reduce separation of a specified position and the locator from each other, and can thus avoid letting the user feel awkward about the operation. The information processing device, therefore, allows the user to easily specify a time period corresponding to how much of content is supposed to have been outputted and consequently allows the user to enjoy improved convenience during output of the content.

Mode 5 of the present invention is an information processing device which is based on mode 4 and which may be arranged such that the transmitting means transmits, as the information on the position of the locator as moved through the operation by the user, information on a position of the locator as moved from a current position of the locator on the seek bar in the direction toward the second specified position by a movement amount equal to a product of the length of the path, which length has been measured by the measuring means, and the rate, which has been set by the setting means.

The information processing device, with the above arrangement, calculates a movement amount for the locator which movement amount is equal to the product of the length of the path and the rate. The information processing device then transmits, as the information on the position of the locator as moved through the operation by the user, information on a position of the locator as moved from the current position of the locator on the seek bar in a direction toward the second specified position by the above movement amount.

In a case where, for instance, the information processing device has set the rate at 2.0, it calculates the movement amount to return a length double the above length, so that the locator is moved over such a double length. In other words, the locator is moved over a distance longer than the distance over which the user has moved a touch position across the input surface within a predetermined time interval (that is, the locator is moved fast).

The information processing device can, with the above arrangement, further reduce separation of a specified position and the locator from each other, and can thus avoid letting the user feel awkward about the operation. The information processing device, therefore, allows the user to easily specify a time period corresponding to how much of content is supposed to have been outputted and that consequently allows the user to enjoy further improved convenience during output of the content.

Mode 6 of the present invention is an information processing device which is based on mode 4 or 5 and which may be arranged such that the setting means sets the rate of the conjunction so that the position of the locator, which position is calculated from the length of the path and the rate of the conjunction, coincides with the second specified position.

The information processing device, with the above arrangement, sets the rate of the conjunction so that the position of the locator, which position is calculated from the length of the path and the rate, coincides with the second specified position. This allows the information processing device to reduce separation of a specified position and the locator from each other and thus avoid letting the user feel awkward about the operation.

The information processing device, therefore, allows the user to easily specify a time period corresponding to how much of content is supposed to have been outputted and that consequently allows the user to enjoy further improved convenience during output of the content.

Mode 7 of the present invention is an information processing device which is based on any one of modes 4 to 6 and which may be arranged such that the second determining means further determines whether the locator is moved behind the movement of the operation in a direction extending from the first specified position to the second specified position; and the setting means, in a case where the second determining means has determined that the locator is moved behind the movement of the operation, sets the rate of the conjunction at a value that corresponds to the length of the path and that is greater than 1 and, in a case where the second determining means has determined that the locator is not moved behind the movement of the operation, sets the rate of the conjunction at a value that corresponds to the length of the path and that is smaller than 1.

With the above arrangement, the information processing device, (i) in a case where the locator is moved behind the movement of the operation in a direction extending from the first specified position to the second specified position (that is, the direction in which the user moves a finger touching the input surface), sets the rate of the conjunction at a value that corresponds to the length of the path and that is greater than 1, and (ii) in a case where the locator is not moved behind the movement of the operation in the above direction, sets the rate of the conjunction at a value that corresponds to the length of the path and that is smaller than 1.

The information processing device can, with the above arrangement, reduce separation of a specified position and the locator from each other regardless of the relative relationship between the specified position and the position of the locator. The information processing device, therefore, allows the user to easily specify a time period corresponding to how much of content is supposed to have been outputted and that consequently allows the user to enjoy further improved convenience during output of the content.

Mode 8 of the present invention is an information processing device which is based on any one of modes 1 to 7 and which may be arranged such that the setting means assigns a predetermined value to the rate of the conjunction between the operation by the user and the movement of the locator to set the rate of the conjunction.

The information processing device, with the above arrangement, assigns a predetermined value to the rate of the conjunction between the operation by the user and the movement of the locator to set the rate of the conjunction. The information processing device, in other words, sets the rate at a preset value.

The information processing device, therefore, allows the user to easily specify a time period corresponding to how much of content is supposed to have been outputted and that consequently allows the user to enjoy further improved convenience during output of the content.

Mode 9 of the present invention is an output device for outputting content which output device may include: calculating means (display control section 71) for calculating, from the information on the position of the locator on the seek bar, which information has been transmitted from the information processing device based on any one of modes 1 to 8, a time period corresponding to an amount of content which amount is supposed to have been outputted; and outputting means (display control section 71) for outputting the content from a location immediately after the time period calculated by the calculating means.

With the above arrangement, the output device calculates, from the information on the position of the locator on the seek bar, which information has been received from the information processing device, a time period corresponding to an amount of content which amount is supposed to have been outputted. The output device then starts outputting the content from a location immediately after the time period calculated.

The output device, therefore, allows the user to easily specify a time period corresponding to how much of content is supposed to have been outputted and consequently allows the user to enjoy improved convenience during output of the content.

Mode 10 of the present invention is an electronic device including an input surface capable of detecting a position on the input surface which position has been specified through an operation by a user, the electronic device including: the information processing device based on any one of modes 1 to 8; and the output device based on mode 9.

The electronic device, therefore, produces effects similar to those produced by the information processing device or output device.

Mode 11 of the present invention is a method for controlling an information processing device that allows a seek bar to be displayed which seek bar shows movement of a locator to indicate an amount of content which amount an output device has outputted and that is capable of specifying, by transmitting information on a position of the locator on the seek bar to the output device, a time period corresponding to an amount of the content which amount the output device is supposed to have outputted, the method including: a measuring step (S3, S12) of measuring, in response to an input surface of an electronic device detecting an operation by a user at a position on the input surface, a length of a path extending from (i) a first specified position for the operation by the user, the first specified position being first detected on the input surface, to (ii) a second specified position for the operation by the user, the second specified position being further detected on the input surface after movement of the operation by the user on the input surface; a setting step (S5, S14a) of setting a rate of conjunction between the operation by the user and the movement of the locator in correspondence with the length of the path, which length has been measured in the measuring step; and a transmitting step (S7) of transmitting, as the information on the position of the locator as moved through the operation by the user, information on a position on the seek bar which position is capable of being calculated from the length of the path, which length has been measured in the measuring step, and the rate, which has been set in the setting step.

With the above arrangement, the method for controlling an information processing device includes features similar to those of the information processing device of mode 1, and therefore produces effects similar to those produced by the information processing device.

Mode 12 of the present invention is a method which is based on mode 11 and which may further include: a detecting step (S13) of detecting whether the length of the path, which length has been measured in the measuring step, is larger than a predetermined threshold value; and a determining step (S16) of, in a case where the detecting step has detected that the length of the path is larger than the predetermined threshold value, determining whether the second specified position coincides with the position of the locator, wherein: the setting step (S14b, S14c), in a case where the determining step has determined that the second specified position does not coincide with the position of the locator, sets the rate of the conjunction between the operation by the user and the movement of the locator; and the transmitting step (S18) transmits, as the information on the position of the locator as moved through the operation by the user, information on a position on the seek bar which position is capable of being calculated from the length of the path, which length has been measured in the measuring step, and the rate, which has been set in the setting step, and which position is located in a direction toward the second specified position.

With the above arrangement, the method for controlling an information processing device includes features similar to those of the information processing device of mode 4, and therefore produces effects similar to those produced by the information processing device.

Another mode of the present invention is an information processing device that allows a seek bar to be displayed which seek bar shows movement of a locator to indicate an amount of content which amount an output device has outputted and that is capable of specifying, by transmitting information on a position of the locator on the seek bar to the output device, a time period corresponding to an amount of the content which amount the output device is supposed to have outputted, the information processing device including: measuring means for measuring, in response to an input surface of an electronic device detecting an operation by a user at a position on the input surface, a length of a path extending from (i) a first specified position for the operation by the user, the first specified position being first detected on the input surface, to (ii) a second specified position for the operation by the user, the second specified position being further detected on the input surface after movement of the operation by the user on the input surface; detecting means for detecting whether the length of the path, which length has been measured by the measuring means, is larger than a predetermined threshold value; determining means for, in a case where the detecting means has detected that the length of the path is larger than the predetermined threshold value, determining whether the second specified position coincides with the position of the locator; setting means for setting a rate of conjunction between the operation by the user and the movement of the locator in a case where the determining means has determined that the second specified position does not coincide with the position of the locator; and transmitting means for transmitting, as the information on the position of the locator as moved through the operation by the user, information on a position on the seek bar which position is capable of being calculated from the length of the path, which length has been measured by the measuring means, and the rate, which has been set by the setting means, and which position is located in a direction toward the second specified position.

Another mode of the present invention is a method for controlling an information processing device that allows a seek bar to be displayed which seek bar shows movement of a locator to indicate an amount of content which amount an output device has outputted and that is capable of specifying, by transmitting information on a position of the locator on the seek bar to the output device, a time period corresponding to an amount of the content which amount the output device is supposed to have outputted, the method including: a measuring step of measuring, in response to an input surface of an electronic device detecting an operation by a user at a position on the input surface, a length of a path extending from (i) a first specified position for the operation by the user, the first specified position being first detected on the input surface, to (ii) a second specified position for the operation by the user, the second specified position being further detected on the input surface after movement of the operation by the user on the input surface; a detecting step of detecting whether the length of the path, which length has been measured in the measuring step, is larger than a predetermined threshold value; a determining step of, in a case where the detecting step has detected that the length of the path is larger than the predetermined threshold value, determining whether the second specified position coincides with the position of the locator; a setting step of setting a rate of conjunction between the operation by the user and the movement of the locator in a case where the determining step has determined that the second specified position does not coincide with the position of the locator; and a transmitting step of transmitting, as the information on the position of the locator as moved through the operation by the user, information on a position on the seek bar which position is capable of being calculated from the length of the path, which length has been measured in the measuring step, and the rate, which has been set in the setting step, and which position is located in a direction toward the second specified position.

The information processing device may be in the form of a computer. In this case, the present invention also covers in its scope (i) a control program for causing a computer to operate as each of the means of the information processing device so that the information processing device is in the form of a computer and (ii) a computer-readable recording medium storing that control program thereon.

### INDUSTRIAL APPLICABILITY

The present invention is applicable to, for example, an electronic device including an input surface capable of detecting a position on the input surface which position has been specified through a user operation. Examples of such an electronic device include a smartphone, a mobile telephone, a personal computer, and a tablet terminal.

### REFERENCE SIGNS LIST

1 locator position (position of a locator)
2 length (length of a path)
3 rate (rate of conjunction)
4a user operation (operation by a user)
4b path
5a specified position (first specified position)
5b specified position (second specified position)
5c movement amount
6 seek bar
7 locator
7a locator
7b locator
8 content
11a control section (information processing device)
11b control section (information processing device)
12 length measuring section (measuring means)
13 length determining section (first determining means)
14a rate setting section (setting means)
14b rate setting section (setting means)
15a position information transmitting section (transmitting means)
15b position information transmitting section (transmitting means)
16 length detecting section (detecting means)
17 coincidence determining section (second determining means)
30 storage section
41 input surface
70 display section (output device)
71 display control section (calculating means, outputting means)
72 display surface
100 smartphone (electronic device)
101 smartphone (electronic device)

1. An information processing device that allows a seek bar to be displayed which seek bar shows movement of a locator to indicate an amount of content which amount an output device has outputted and that is capable of specifying, by transmitting information on a position of the locator on the seek bar to the output device, a time period corresponding to an amount of the content which amount the output device is supposed to have outputted,
the information processing device comprising:
measuring means for measuring, in response to an input surface of an electronic device detecting an operation by a user at a position on the input surface, a length of a path extending from (i) a first specified position for the operation by the user, the first specified position being first detected on the input surface, to (ii) a second specified position for the operation by the user, the second specified position being further detected on the input surface after movement of the operation by the user on the input surface;
setting means for setting a rate of conjunction between the operation by the user and the movement of the locator in correspondence with the length of the path, which length has been measured by the measuring means; and
transmitting means for transmitting, as the information on the position of the locator as moved through the operation by the user, information on a position on the seek bar which position is capable of being calculated from the length of the path, which length has been measured by the measuring means, and the rate, which has been set by the setting means.

2. The information processing device according to claim 1,
wherein
the transmitting means transmits, as the information on the position of the locator as moved through the operation by the user, information on a position of the locator as moved from a current position of the locator on the seek bar by a movement amount equal to a product of the length of the path, which length has been measured by the measuring means, and the rate, which has been set by the setting means.

3. The information processing device according to claim 1, further comprising
first determining means for determining whether the length of the path, which length has been measured by the measuring means, is smaller than a predetermined threshold value,
wherein
the setting means, in a case where the first determining means has determined that the length of the path is smaller than the predetermined threshold value, sets the rate of the conjunction in correspondence with the length of the path.

4. The information processing device according to claim 1, further comprising:
detecting means for detecting whether the length of the path, which length has been measured by the measuring means, is larger than a predetermined threshold value; and
second determining means for, in a case where the detecting means has detected that the length of the path is larger than the predetermined threshold value, determining whether the second specified position coincides with the position of the locator,
wherein:
the setting means, in a case where the second determining means has determined that the second specified position does not coincide with the position of the locator, sets the rate of the conjunction between the operation by the user and the movement of the locator; and
the transmitting means transmits, as the information on the position of the locator as moved through the operation by the user, information on a position on the seek bar which position is capable of being calculated from the length of the path, which length has been measured by the measuring means, and the rate, which has been set by the setting means, and which position is located in a direction toward the second specified position.

5. The information processing device according to claim 4,
wherein
the transmitting means transmits, as the information on the position of the locator as moved through the operation by the user, information on a position of the locator as moved from a current position of the locator on the seek bar in the direction toward the second specified position by a movement amount equal to a product of the length of the path, which length has been measured by the measuring means, and the rate, which has been set by the setting means.

6. The information processing device according to claim 4,
wherein
the setting means sets the rate of the conjunction so that the position of the locator, which position is calculated from the length of the path and the rate of the conjunction, coincides with the second specified position.

7. The information processing device according to claim 4,
wherein:
the second determining means further determines whether the locator is moved behind the movement of the operation in a direction extending from the first specified position to the second specified position; and
the setting means, in a case where the second determining means has determined that the locator is moved behind the movement of the operation, sets the rate of the conjunction at a value that corresponds to the length of the path and that is greater than 1 and, in a case where the second determining means has determined that the locator is not moved behind the movement of the operation, sets the rate of the conjunction at a value that corresponds to the length of the path and that is smaller than 1.

8. The information processing device according to claim 1,
wherein
the setting means assigns a predetermined value to the rate of the conjunction between the operation by the user and the movement of the locator to set the rate of the conjunction.

9. An output device for outputting content,
the output device comprising:
calculating means for calculating, from the information on the position of the locator on the seek bar, which information has been transmitted from the information processing device according to claim 1, a time period corresponding to an amount of content which amount is supposed to have been outputted; and
outputting means for outputting the content from a location immediately after the time period calculated by the calculating means.

10. An electronic device including an input surface capable of detecting a position on the input surface which position has been specified through an operation by a user, the electronic device comprising:
the information processing device according to claim 1; and
an output device including
the output device comprising:
calculating means for calculating, from the information on the position of the locator on the seek bar, which information has been transmitted from the information processing device, a time period corresponding to an amount of content which amount is supposed to have been outputted; and
outputting means for outputting the content from a location immediately after the time period calculated by the calculating means.

11. A method for controlling an information processing device that allows a seek bar to be displayed which seek bar shows movement of a locator to indicate an amount of content which amount an output device has outputted and that is capable of specifying, by transmitting information on a position of the locator on the seek bar to the output device, a time period corresponding to an amount of the content which amount the output device is supposed to have outputted,
the method comprising:
a measuring step of measuring, in response to an input surface of an electronic device detecting an operation by a user at a position on the input surface, a length of a path extending from (i) a first specified position for the operation by the user, the first specified position being first detected on the input surface, to (ii) a second specified position for the operation by the user, the second specified position being further detected on the input surface after movement of the operation by the user on the input surface;
a setting step of setting a rate of conjunction between the operation by the user and the movement of the locator in correspondence with the length of the path, which length has been measured in the measuring step; and
a transmitting step of transmitting, as the information on the position of the locator as moved through the operation by the user, information on a position on the seek bar which position is capable of being calculated from the length of the path, which length has been measured in the measuring step, and the rate, which has been set in the setting step.

12. The method according to claim 11, further comprising:
a detecting step of detecting whether the length of the path, which length has been measured in the measuring step, is larger than a predetermined threshold value; and
a determining step of in a case where the detecting step has detected that the length of the path is larger than the predetermined threshold value, determining whether the second specified position coincides with the position of the locator,
wherein:
the setting step, in a case where the determining step has determined that the second specified position does not coincide with the position of the locator, sets the rate of the conjunction between the operation by the user and the movement of the locator; and
the transmitting step transmits, as the information on the position of the locator as moved through the operation by the user, information on a position on the seek bar which position is capable of being calculated from the length of the path, which length has been measured in the measuring step, and the rate, which has been set in the setting step, and which position is located in a direction toward the second specified position.

13. (canceled)

14. A non-transitory computer-readable recording medium storing thereon the control program for causing a computer to function as the information processing device according to claim 1, the control program causing the computer to function as each of the means.
